(19) United States
(12) Patent Application Publication
(10) Pub. No.: US 2017/0300163 A1
(43) Pub. Date: Oct. 19, 2017

(54) TOUCH DISPLAY PANEL AND DRIVING METHOD THEREOF

(71) Applicant: AU OPTRONICS CORPORATION, Hsin-chu (TW)

(72) Inventors: I-Hsiung HUANG, Hsin-chu (TW); Yi-San HSIEH, Hsin-chu (TW); Shih-Lun LAI, Hsin-chu (TW)

(21) Appl. No.: 15/275,599

(22) Filed: Sep. 26, 2016

(30) Foreign Application Priority Data
Apr. 13, 2016 (TW) 105111510

(51) Int. Cl. G06F 3/041; G06F 3/044

(52) U.S. Cl. CPC G06F 3/0416; G06F 3/044; G06F 3/0412; G06F 2203/04107; G06F 2203/04105

(57) ABSTRACT

A touch display panel and the driving method thereof are disclosed herein. The touch display panel comprises a plurality of first sensing electrodes, a plurality of second sensing electrodes, and a plurality of third sensing electrodes. The first sensing electrodes are configured to output a scanning signal. The second sensing electrodes are configured to generate a pressure detecting signal according to the scanning signal in a first period of a frame, and generate a touch detecting signal according to the scanning signal in a second period of the frame. The third sensing electrodes are arranged between the second sensing electrodes and configured to receive a predetermined voltage with a fixed level in the first period, and to be in a floating state in the second period.

### CROSS-REFERENCE TO RELATED APPLICATION

This non-provisional application claims priority to and benefit of, under 35 U.S.C. §119(a), Patent Application No. 105111510 filed in Taiwan R.O.C. on Apr. 13, 2016, the entire content of which is hereby incorporated by reference.

### TECHNICAL FIELD

The present disclosure relates to a touch display panel and a driving method thereof, and particularly, to a touch display panel capable of executing pressure detection, and a driving method thereof.

### BACKGROUND

With the development of capacitive touch technology, an existing capacitive touch display not only can detect a position of a finger of a user, but also can detect a value of a pressure exerted by the user.

However, when the user exerts a pressure on the touch display, a change in a contact area between the finger and the screen leads to a detection error of a detecting signal, which reduces detection accuracy and may also cause an erroneous operation of a system in a serious case.

### SUMMARY

To solve the foregoing problem, an embodiment of the present disclosure is a touch display panel. The touch display panel comprises a plurality of first sensing electrodes, a plurality of second sensing electrodes, and a plurality of third sensing electrodes. The first sensing electrodes are configured to output a scanning signal. The second sensing electrodes are configured to generate a pressure detecting signal according to the scanning signal in a first period of a frame, and generate a touch detecting signal according to the scanning signal in a second period of the frame. The third sensing electrodes are arranged between the second sensing electrodes and configured to receive a predetermined voltage with a fixed level in the first period, and to be in a floating state in the second period.

Another embodiment of the present disclosure provides a driving method of a touch display panel. The driving method comprises: outputting a scanning signal on first sensing electrodes; providing a predetermined voltage to third sensing electrodes in a first operation stage; reading a pressure detecting signal from second sensing electrodes, wherein the pressure detecting signal is generated according to the scanning signal in the first operation stage; controlling the third sensing electrodes to be in a floating state in a second operation stage; and reading a touch detecting signal from the second sensing electrodes, wherein the touch detecting signal is generated according to the scanning signal in the second operation stage.

In conclusion, by using the foregoing embodiments in the disclosure, shielding electrodes are disposed in a touch display panel, and states of the shielding electrodes are switched according to detection modes, to detect a variation of finger sensing capacitance and a variation of mutual capacitance between sensing electrodes in different periods of a frame, so as to implement touch detection and pressure detection. In this way, the accuracy of touch detection and pressure detection in the touch display panel can be improved, to alleviate various problems in the prior art.

### BRIEF DESCRIPTION OF THE DRAWINGS

FIG. 1 is a schematic diagram of a capacitive touch identification technology depicted according to some embodiments of the present disclosure;

FIG. 2 is a schematic diagram of a touch display panel according to some embodiments of the present disclosure;

FIG. 3 is a waveform diagram of a switching signal shown in FIG. 2 according to some embodiments of the present disclosure;

FIG. 4 is a side sectional view of a touch display panel according to some embodiments of the present disclosure;

FIG. 5 is a schematic diagram of a touch display panel according to some other embodiments of the present disclosure; and

FIG. 6 is a flowchart of a driving method according to some embodiments of the content of the present disclosure.

### DETAILED DESCRIPTION

Detailed descriptions are provided below with reference to embodiments in combination with the accompanying drawings, for better comprehension of the embodiments of the present disclosure. However, the provided embodiments are not intended to limit the scope of the present disclosure, and the description about structures and operations are not intended to limit an execution sequence thereof; any structure formed by a recombination of elements and any apparatus producing equivalent efficacy fall within the scope of the present disclosure. In addition, according to the standard and common practice in the industry, the drawings are merely provided for the purpose of auxiliary illustration, and are not drawn according to original sizes; in fact, sizes of various features may be randomly increased or reduced to facilitate the description. In the following description, identical elements are described by using identical reference numerals, to facilitate comprehension.

Unless particularly specified, terms used throughout the whole specification and the claims generally have common meaning as each term is used in this field, in the content of the present disclosure and special content. Some terms used to describe the present disclosure will be discussed below or in other parts of the specification, to provide a person skilled in the art with an extra guide regarding the description of the present disclosure.

In addition, terms such as “comprise,” “include,” “have” and “contain” herein are open terms, that is, the terms mean “include but is not limited to.” In addition, the term “and/or” used herein include any one of or all combinations of one or more items in related items listed.

Herein, when an element is referred to as being in “connection” or “coupling,” it may refer to “electrical connection” or “electrical coupling.” Then “connection” or “coupling” may also be used to represent cooperative operations or interaction between two or more elements. In addition, although terms such as “first” and “second” are used herein to describe different elements, the terms are merely used to differentiate elements or operations described by using a same technical term. Unless explicitly pointed out in the context, the terms do not specially indicate or imply the sequence or order, and are not intended to limit the preset invention.

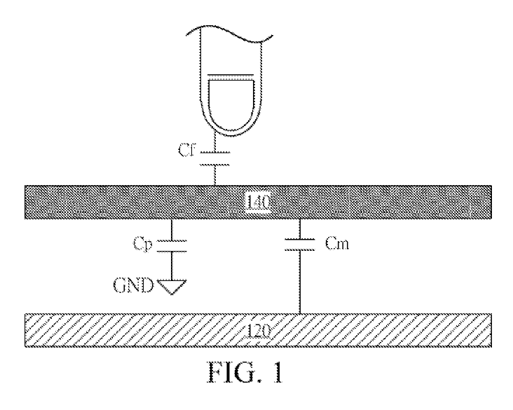

Please refer to FIG. 1. FIG. 1 is a schematic diagram of a capacitive touch identification technology according to some embodiments of the present disclosure. In the embodiment shown in FIG. 1, a sensing electrode 120 is used as a scanning electrode, and a sensing electrode 140 is used as a detecting electrode. As shown in FIG. 1, a mutual capacitance Cm exists between the sensing electrode 120 and the sensing electrode 140, and a parasitic capacitance Cp exists between the sensing electrode 140 and the ground terminal GND. In the capacitive touch identification technology, before a finger of a user approaches the sensing electrode 140, the sensing electrode 120 transfers a scanning signal Tx, and the sensing electrode 140 is enabled to generate a corresponding detecting signal Rx through the mutual capacitance Cm and the parasitic capacitance Cp.

When the user's finger approaches an array formed by the sensing electrode 120 and the sensing electrode 140, finger sensing capacitance Cf is generated between the sensing electrode 140 and the finger. Because the finger sensing capacitance Cf changes an overall capacitance value, the detecting signal Rx output by the sensing electrode 140 also changes. In this way, a logic circuit can read a change in the detecting signal Rx subsequently to determine a relative position of the user's finger on the touch panel, to implement touch identification.

In addition, in some embodiments, the capacitive touch identification technology may be further used to detect a pressure value of the user's finger and identify an operation of the user according to a pressure value difference. Specifically, when the user's finger exerts a pressure on the sensing electrode 140, a distance between the sensing electrode 140 and the sensing electrode 120 is deformed according to the pressure value, further causing the mutual capacitance value Cm to change. Because the change in the mutual capacitance value Cm causes the overall capacitance value to change, the detecting signal Rx output by the sensing electrode 140 also changes. In this way, the logic circuit can read the change in the detecting signal Rx subsequently to determine the value of pressure exerted by the user's finger on the touch panel, to implement pressure identification.

However, when the pressure value changes, an area between the user's finger and the sensing electrode 140 also changes, causing the finger sensing capacitance Cf to change. Therefore, when the logic circuit performs pressure detection, the overall capacitance value change which is reflected by the detecting signal Rx output by the sensing electrode 140 cannot accurately reflect a change in the mutual capacitance value Cm that is generated due to a change in the pressure.

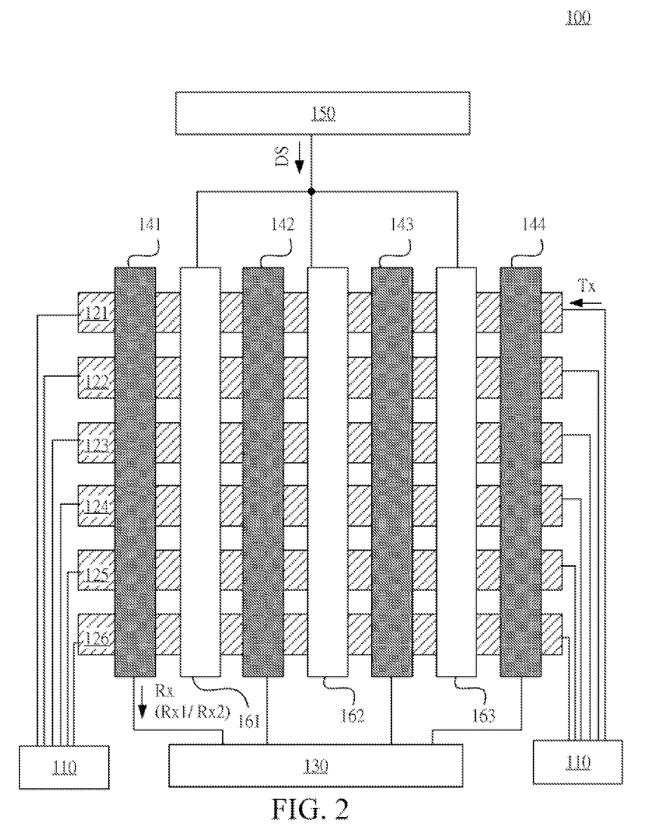

Please refer to FIG. 2. FIG. 2 is a schematic diagram of a touch display panel 100 according to some embodiments of the present disclosure. In some embodiments, the touch display panel 100 comprises sensing electrodes 121 to 126, 141 to 144, and 161 to 163, a scanning signal providing circuit 110, a touch logic circuit 130, and a sensing selection circuit 150.

In some embodiments, the sensing electrodes 121 to 126 are used as scanning electrodes, and are arranged with the sensing electrodes 141 to 144 and 161 to 163 to form an array. The sensing electrodes 141 to 144 are used as detecting electrodes. The sensing electrodes 161 to 163 are arranged between the sensing electrodes 141 to 144, to be used as shielding electrodes.

The sensing electrodes 121 to 126 are configured to receive and output a scanning signal Tx from the scanning signal providing circuit 110. The sensing electrodes 141 to 144 are configured to generate a detecting signal Rx according to the scanning signal Tx. Specifically, in some embodiments, in different periods of a frame, the sensing electrodes 141 to 144 may generate detecting signals Rx, such as a pressure detecting signal Rx1 and a touch detecting signal Rx2, according to the scanning signal Tx. For example, the sensing electrodes 141 to 144 may execute pressure detection in a first period of a frame, to generate the pressure detecting signal Rx1, and execute touch detection in a second period of the same frame, to generate the touch detecting signal Rx2, where a specific implementation manner will be described in the following paragraphs with reference to the related drawings.

In some embodiments, the touch logic circuit 130 is electrically connected to the sensing electrodes 141 to 144, and is configured to generate, according to the touch detecting signal Rx2, touch position data that represents a touch position, and generate, according to the pressure detecting signal Rx1, pressure value data that represents a touch force. In this way, the touch logic circuit 130 can determine the touch position of the user's finger according to the touch position data when touch detection is performed, and determine a value and state of a touch force of the user's finger according to the pressure value data when pressure detection is performed. In some embodiments, the touch logic circuit 130 can make the sensing electrodes 141 to 144 conductive according to a selection signal, so as to detect and read the corresponding detecting signal Rx on the sensing electrodes 141 to 144.

In some embodiments, the sensing selection circuit 150 is electrically connected to the sensing electrodes 161 to 163, and is configured to selectively output a switching signal DS respectively. Specifically, when the sensing electrodes 161 to 163 are in the first period, a corresponding switching signal DS controls the sensing electrodes 161 to 163 to receive a predetermined voltage with a fixed level, and when the sensing electrodes 161 to 163 are in the second period, a corresponding switching signal DS controls the sensing electrodes 161 to 163 to be in a floating state. In some embodiments, the foregoing predetermined voltage with the fixed level may be generally a zero voltage, but the present disclosure is not limited thereto.

In this way, when the sensing electrodes 141 to 144 execute pressure detection in the first period of a frame, the sensing electrodes 161 to 163 having the fixed level can provide shielding function, to reduce influence of the finger sensing capacitance Cf on the overall capacitance value, as illustrated in FIG. 1. Therefore, the pressure detecting signal Rx1 generated by the sensing electrodes 141 to 144 can present a change in the mutual capacitance Cm which is caused by a distance change as the pressure exerted by the finger changes. In other words, the pressure detecting signal Rx1 may correspond to a change in a perpendicular distance between the sensing electrodes 141 to 144 and the sensing electrodes 121 to 126.

Correspondingly, when the sensing electrodes 141 to 144 execute touch detection in the second period, the sensing electrodes 161 to 163 are in the floating state, and there is no fixed voltage shielding. Therefore, the touch detecting signal Rx2 generated by the sensing electrodes 141 to 144 can present impact of the finger sensing capacitance Cf, which is generated in a region where the user's finger is located, on the overall capacitance value.

Therefore, in the touch display panel 100, the sensing electrodes 161 to 163 are switched between the floating state and a fixed level state in different detection modes, which can reduce an error of the detecting signal Rx received by the touch logic circuit 130 in different detection modes, so as to improve the sensitivity and accuracy when the touch display panel 100 executes detection.

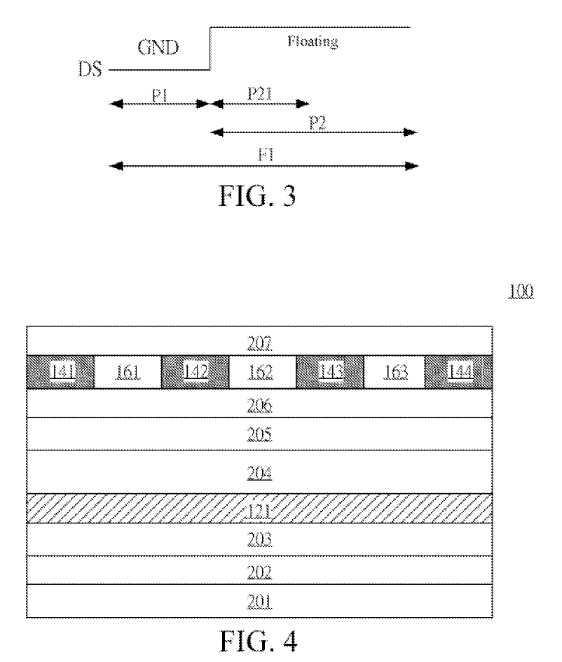

Please refer to FIG. 3 in combination. FIG. 3 is a waveform diagram of a switching signal shown in FIG. 2 according to some embodiments of the present disclosure. As shown in FIG. 3, in this embodiment, a frame F1 comprises a pressure detecting period P1 and an image displaying period P2. The touch display panel 100 may display an image by means of a display array in the image displaying period P2, wherein the image displaying period P2 further comprises a touch detecting period P21. In the pressure detecting period P1, the switching signal DS provides a predetermined voltage with a fixed level for shielding. For example, in this embodiment, the switching signal DS provides a GND voltage to the ground terminal. In the image displaying period P2, the switching signal DS controls the sensing electrodes 161 to 163 to be in a floating state. In this way, when touch detection is executed in the touch detecting period P21 of the image displaying period P2, a change in the finger sensing capacitance Cf is detected.

In addition, in some embodiments, the touch logic circuit 130 may also perform a subtraction operation on a capacitance change detected in the pressure detecting period P1 and a capacitance change detected in the touch detecting period P21, so as to more accurately calculate respective changes of the finger sensing capacitance Cf and the mutual capacitance Cm in the overall capacitance value change.

Please refer to FIG. 4. FIG. 4 is a side sectional view of a touch display panel depicted according to some embodiments of the present disclosure. For the convenience and clarity of the description, the touch display panel 100 illustrated in FIG. 4 may be described with reference to the embodiment illustrated in FIG. 2, but is not limited thereto. In FIG. 4, similar elements related to the embodiment in FIG. 2 are represented by same reference numerals, to facilitate comprehension.

As shown in FIG. 4, the touch display panel 100 further comprises a polarizing plate 201, a thin film transistor substrate 202, a pixel array 203, a display medium layer 204, a color filter 205, a color filter substrate 206 and a polarizing plate 207. The thin film transistor substrate 202 and the pixel array 203 thereon are arranged above the polarizing plate 201, and the color filter 205 is arranged above thin film transistor substrate 202. The display medium layer 204 is arranged between the thin film transistor substrate 202 and the color filter 205. The color filter substrate 206 and the polarizing plate 207 are arranged above the color filter 205. In some embodiments, the thin film transistor substrate 202 and the color filter substrate 207 may be glass substrates.

Continue to refer to FIG. 4. As shown in the figure, the sensing electrodes 121 to 126 in the foregoing embodiment are disposed in a conductive metal layer on the thin film transistor substrate 202. Specifically, in some embodiments, the sensing electrodes 121 to 126 may be common voltage electrodes of a plurality of pixels in the pixel array 203, so as to simplify a circuit design of the sensing electrodes. In addition, the sensing electrodes 141 to 144 and the sensing electrodes 161 to 163 are arranged in an alternating manner and are disposed in another conductive metal layer on the color filter substrate 206. In this way, when the user exerts a relatively large pressure, a distance between the thin film transistor substrate 202 and the color filter substrate 206 changes, and distances from the sensing electrodes 121 to 126 to the sensing electrodes 141 to 144 and the sensing electrodes 161 to 163 disposed thereon also change accordingly.

It should be noted that, FIG. 4 merely illustrates one of possible implementation manners of the content of the present disclosure, and is not intended to limit the present disclosure. In other embodiments, a person of ordinary skill in the part may also correspondingly dispose the sensing electrodes 121 to 126 and the sensing electrodes 141 to 144 and 161 to 163 on a structure of a type that is different from the display panel.

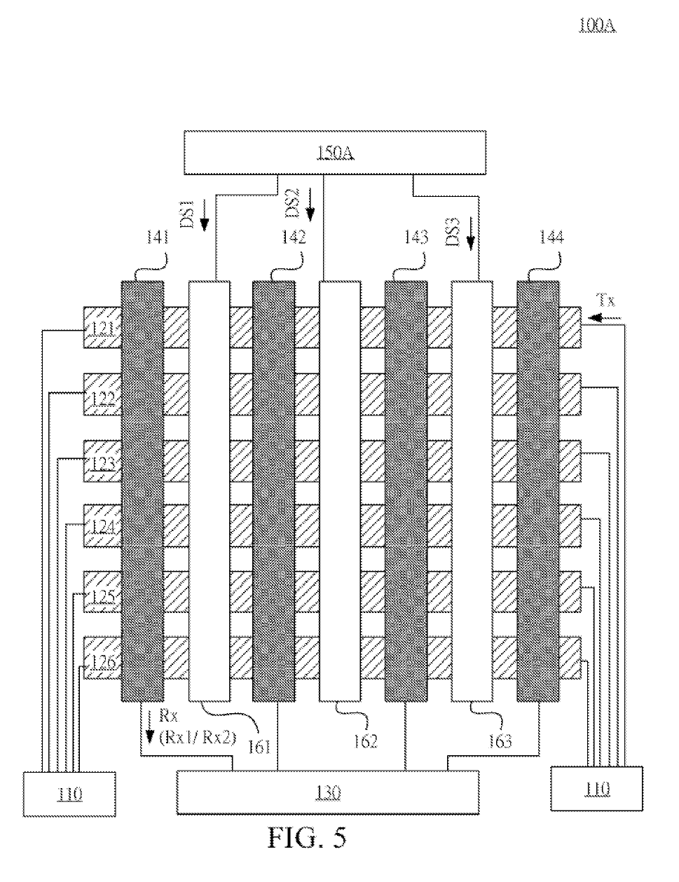

Please refer to FIG. 5. FIG. 5 is a schematic diagram of a touch display panel 100A depicted according to some other embodiments of the present disclosure. In FIG. 5, similar elements related to the embodiment in FIG. 2 are represented by same reference numerals, to facilitate comprehension. Compared with the embodiment illustrated in FIG. 2, in this embodiment, a sensing selection circuit 150A selectively outputs switching signals DS1, DS2 and DS3 to the sensing electrodes 161 to 163 respectively. In this way, the sensing electrodes 161 to 163 can be in different voltage states according to the corresponding switching signals DS1 to DS3.

In other words, the sensing electrodes 161 to 163 may be divided into a first group and a second group. When the switching signal DS1 controls the first group of sensing electrodes (for example, the sensing electrode 161) to be in a floating state, the switching signals DS2 and DS3 control the second group of sensing electrodes (for example, the sensing electrodes 162 and 163) to be configured to receive a predetermined voltage. Correspondingly, when the switching signal DS1 controls the first group of sensing electrodes (for example, the sensing electrode 161) to be configured to receive the predetermined voltage, the switching signals DS2 and DS3 control the second group of sensing electrodes (for example, the sensing electrodes 162 and 163) to be in the floating state.

In this way, in the embodiment illustrated in FIG. 5, the touch display panel 100A can separately execute pressure detection and touch detection in different regions on the panel, and locations and areas of the region in which the pressure detection is executed and the region in which touch detection is executed can be dynamically adjusted according to a requirement. For example, in some embodiments, after the region touched by the user's finger is determined on the touch display panel 100A, the predetermined voltage can be provided to shielding electrodes near the region to execute pressure detection, thereby maintaining other shielding electrodes at the floating state, to continue to execute touch detection.

It should be noted that, in order to simplify the description, the quantities of the sensing electrodes 121 to 126, 141 to 144, and 161 to 163 shown in the foregoing embodiments are merely used for the illustrative purpose. A person skilled in the art may increase or decrease the quantities of the sensing electrodes 121 to 126, 141 to 144, and 161 to 163, which is also a possible implementation manner of the content of the present disclosure. Similarly, the sensing electrodes 161 to 163 may be randomly classified into a first group of sensing electrodes and a second group of sensing electrodes, or even into more groups of sensing electrodes, which is also a possible implementation manner of the content of the present disclosure.

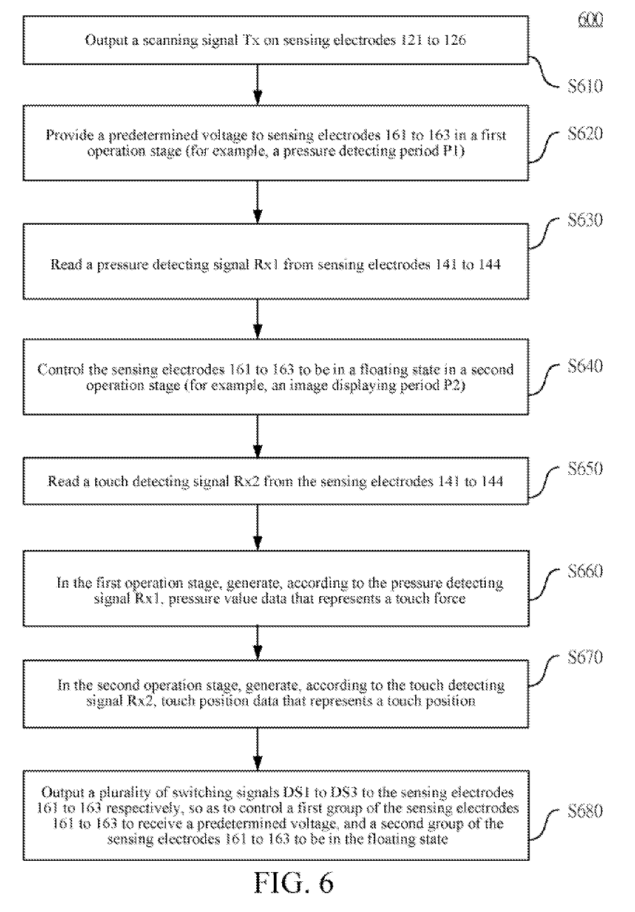

Another embodiment of the present disclosure is a driving method of a touch display panel 100. Please refer to FIG. 6. FIG. 6 is a flowchart of a driving method 600 illustrated according to some embodiments of the content of the present disclosure. For the convenience and clarity of the description, the following driving method 600 is described with reference to the embodiments illustrated in FIG. 1 to FIG. 5, but is not limited thereto. Any person skilled in the art may make various changes and modifications without departing from the spirit and scope of the present disclosure. As shown in FIG. 6, the driving method 600 comprises operations S610, S620, S630, S640 and S650.

First, in operation S610, a scanning signal providing circuit 110 outputs a scanning signal Tx on sensing electrodes 121 to 126. Next, in operation S620, a sensing selection circuit 150 provides a predetermined voltage to sensing electrodes 161 to 163 in a first operation stage (for example, a pressure detecting period P1). Then, in operation S630, a touch logic circuit 130 reads a pressure detecting signal Rx1 from sensing electrodes 141 to 144. The pressure detecting signal Rx1 is generated according to the scanning signal Tx in the first operation stage.

Next, in operation S640, the sensing selection circuit 150 controls the sensing electrodes 161 to 163 to be in a floating state in a second operation stage (for example, an image displaying period P2). Then, in operation S650, the touch logic circuit 130 reads a touch detecting signal Rx2 from the sensing electrodes 141 to 144. The touch detecting signal Rx2 is generated according to the scanning signal Tx in the second operation stage.

In this way, by means of the foregoing driving method, the touch display panel 100 can control operation states of the shielding electrodes, thus improving the accuracy of pressure detection and touch detection, and reducing the detection error.

In some embodiments, the driving method 600 further comprises operations S660 and S670. In operation S660, in the first operation stage, the touch logic circuit 130 generates, according to the pressure detecting signal Rx1, pressure value data that represents a touch force. In operation S670, in the second operation stage, the touch logic circuit 130 generates, according to the touch detecting signal Rx2, touch position data that represents a touch position.

In addition, in some other embodiments, the driving method 600 further comprises operation S680. In operation S680, the sensing selection circuit 150 outputs a plurality of switching signals DS1 to DS3 to the sensing electrodes 161 to 163 respectively, so as to control a first group of the sensing electrodes 161 to 163 in the touch display panel 100 to receive a predetermined voltage, and a second group of the sensing electrodes 161 to 163 to be in the floating state.

Any person of ordinary skill in the art can directly understand how the driving method 600 executes the operations and functions on the basis of the touch display panel 100 in the foregoing embodiments, and therefore, details are not described herein again.

The foregoing content comprises exemplary steps. However, these steps are not necessarily executed in sequence. Unless a sequence is particularly specified, the sequence of the steps mentioned in this implementation manner can be adjusted according to an actual need, or the steps or some of the steps may be executed simultaneously.

In conclusion, according to the present disclosure, by using the foregoing embodiments, shielding electrodes are disposed in a touch display panel 100, and states of the shielding electrodes are switched according to detection modes, to sense a variation of finger sensing capacitance and a variation of mutual capacitance between sensing electrodes in different periods of a frame, so as to implement touch detection and pressure detection. In this way, the accuracy of touch detection and pressure detection in the touch display panel 100 can be improved, to alleviate various problems in the prior art.

Although the content of the present disclosure has been disclosed above by using implementation manners, the implementation manners are not intended to limit the content of the present disclosure. Any person skilled in the art can make various changes and modifications without departing from the spirit and scope of the content of the present disclosure. Therefore, the protection scope of the content of the present disclosure shall be subject to the appended claims.

What is claimed is:

1. A touch display panel, comprising:
a plurality of first sensing electrodes, configured to output a scanning signal;
a plurality of second sensing electrodes, configured to generate a pressure detecting signal according to the scanning signal in a first period of a frame, and generate a touch detecting signal according to the scanning signal in a second period of the frame; and
a plurality of third sensing electrodes, wherein the third sensing electrodes are arranged between the second sensing electrodes and configured to receive a predetermined voltage with a fixed level in the first period, and to be in a floating state in the second period.

2. The touch display panel according to claim 1, further comprising:
a sensing selection circuit, configured to selectively output at least one switching signal respectively, wherein when any one of the third sensing electrodes is in the first period, a corresponding switching signal controls the third sensing electrode to receive the predetermined voltage, and when any one of the third sensing electrodes is in the second period, a corresponding switching signal controls the third sensing electrode to be in the floating state.

3. The touch display panel according to claim 1, wherein the third sensing electrodes comprise a first group of third sensing electrodes and a second group of third sensing electrodes, and when the first group of third sensing electrodes is in the floating state, the second group of third sensing electrodes is configured to receive the predetermined voltage; and
when the first group of third sensing electrodes is configured to receive the predetermined voltage, the second group of third sensing electrodes is in the floating state.

4. The touch display panel according to claim 1, further comprising:
a touch logic circuit, electrically connected to the second sensing electrodes and configured to generate, according to the touch detecting signal, touch position data that represents a touch position and generate, according to the pressure detecting signal, pressure value data that represents a touch force.

5. The touch display panel according to claim 1, wherein the first sensing electrodes are arranged on a thin film transistor substrate of the touch display panel, and the third sensing electrodes and the second sensing electrodes are arranged on a color filter substrate of the touch display panel.

6. The touch display panel according to claim 1, wherein the pressure detecting signal corresponds to a change in a perpendicular distance between the first sensing electrodes and the second sensing electrodes.

7. The touch display panel according to claim 1, further comprising:
a pixel array, wherein the pixel array comprises a plurality of pixels, and the first sensing electrodes are common voltage electrodes of the pixels.

8. A driving method of a touch display panel, the touch display panel comprising a plurality of first sensing electrodes, a plurality of second sensing electrodes and a plurality of third sensing electrodes, the third sensing electrodes being arranged between the second sensing electrodes, and the driving method comprising:
outputting a scanning signal on the first sensing electrodes;
providing a predetermined voltage to the third sensing electrodes in a first operation stage;
reading a pressure detecting signal from the second sensing electrodes, wherein the pressure detecting signal is generated according to the scanning signal in the first operation stage;
controlling the third sensing electrodes to be in a floating state in a second operation stage; and
reading a touch detecting signal from the second sensing electrodes, wherein the touch detecting signal is generated according to the scanning signal in the second operation stage.

9. The driving method according to claim 8, further comprising:
in the first operation stage, generating, by a touch logic circuit according to the pressure detecting signal, pressure value data that represents a touch force; and
in the second operation stage, generating, by the touch logic circuit according to the touch detecting signal, touch position data that represents a touch position.

10. The driving method according to claim 9, further comprising:
outputting a plurality of switching signals to the third sensing electrodes respectively, to control a first group of third sensing electrodes in the touch display panel to receive the predetermined voltage, and a second group of third sensing electrodes in the touch display panel to be in the floating state.
